(19) United States
(12) Patent Application Publication
(10) Pub. No.: US 2021/0402321 A1
(43) Pub. Date: Dec. 30, 2021

(54) METHOD AND DEVICE FOR CLEANING CONTAMINATED USED OIL

(71) Applicant: BIOFABRIK HOYERSWERDA GMBH, Hoyerswerda (DE)

(72) Inventor: Michael RICHTER, Lauta (DE)

(73) Assignee: BIOFABRIK HOYERSWERDA GMBH, Hoyerswerda (DE)

(21) Appl. No.: 17/294,569

(22) PCT Filed: Nov. 19, 2019
(86) PCT No.: PCT/EP2019/081830

§ 371 Date: May 17, 2021

(30) Foreign Application Priority Data
Nov. 19, 2018 (DE) 10 2018 129 001.2

(51) Int. Cl. B01D 3/14; B01D 1/00; B01D 1/02; B01D 1/14; B01D 3/06; C10G 7/00

(52) U.S. Cl. CPC B01D 3/148; B01D 1/0052; B01D 1/02; C10G 2300/1007; B01D 3/06; C10G 7/006; B01D 1/14

(57) ABSTRACT

The invention relates to a method and a device for cleaning contaminated used oil, in which starting material is heated to the gas phase and the resultant vapor is rectified, with purified oil being removed as condensate from a drain in a rectification column. This enables efficient operation even in the smallest of systems, such that a compact system configuration and thus in particular mobile use by a container structure is made possible. The invention also reduces the cost required for servicing. The used oil is subjected to an evaporation process by at least indirectly placing the starting material in contact with a melting bath, the melting temperature of which is above the evaporation temperature but below the ignition temperature of the used oil, and by rectifying the vapor in the rectification column.

The invention relates to the processing of liquid oil-containing residues such as used oil, contaminated diesel, heating oil or maritime oils, here referred to summarily as contaminated used oil, which is used as starting material in the process. The purification of the used oil can be carried out by pure distillation without the molecular structures being changed. However, the invention can also be used in a temperature range in which so-called cracking, i.e. breaking-up of long molecular chains into shorter ones, occurs.

Here, the invention relates to a process for purifying contaminated used oil, in which the starting material is heated until it forms a gas phase and the vapor arising is rectified, with purified oil being taken off as condensate from an offtake in a rectification column.

The invention also relates to an apparatus for purifying contaminated used oil, comprising a main reactor and a rectification column attached thereto.

DE 198 20 635 A1 discloses a process for treating used oil, in which the used oil is subjected to rough purification and subsequent drying, then thermally cracked at from 400 to 500° C. and the cracking product is subject to distillation. To reduce the chlorine content, alkaline compounds are added to the prepurified used oil.

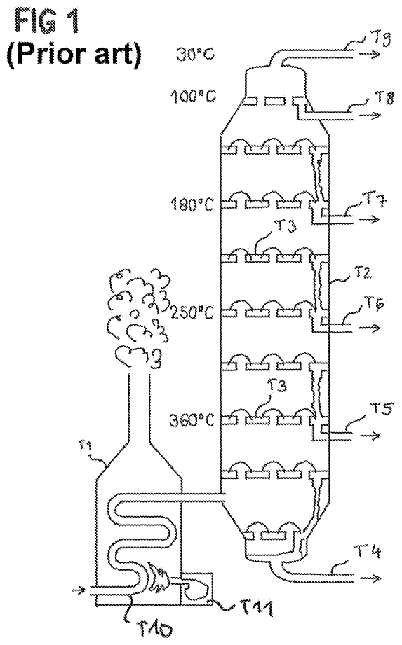

The procedure of cracking and subsequent distillation is known from the heavy oil or crude oil industry and is described, for example, in www.seilnacht.com/versuche/erdoeld.gif and depicted once more in FIG. 1. Here, the crude oil is heated to above 360° C. in a tube oven, so that the constituents largely vaporize. These go into a distillation tower which is made up of numerous bubble cap trays. The distillates of the individual fractions collect in the bubble cap trays. The temperatures of the bubble cap trays decrease toward the top. Any constituent of the ascending vapor then condenses out in any bubble cap tray having a temperature below the boiling point of this constituent. Separation of the individual constituents can be carried out in this way.

In the tube oven, the starting material comes into contact via a heat exchanger with a hot gas. To heat the starting material sufficiently, it is necessary to choose such a temperature difference which makes heating to the target temperature possible. This leads to the inner tube of the heat exchanger tending to become blocked since combustion residues adhere to the inside. The outside is also subjected to high stresses due to the hot gas. This gives rise to a not inconsiderable maintenance requirement. This does not represent a problem in large stationary plants since it is possible to use a plurality of reactors, so that one or more are always available for operation even when others have to be subjected to maintenance. In relatively small and mobile plants, the choice of such redundance is not possible or at least disadvantageous.

DE 10 2012 008 458 A1 discloses a reactor for gasification of starting material, which is filled with a filler and a metal which can be brought into the liquid phase by means of external heating elements. The starting material is introduced into this liquid metal bath on the underside. Use of solid starting material in granular form is envisaged here. This starting material will experience depolymerization due to the temperature of the metal bath. The starting material then goes into the liquid phase and, as a result of delayed permeation through the filler, into the vapor phase and is condensed in a condenser to give an output material and is collected in a collector.

EP 0 592 057 B1 describes a process in which likewise solid starting material is subjected to pyrolysis in a metal bath.

WO 2014/106650 A2 describes a process for converting hydrocarbon-containing starting material into oil, likewise in a metal bath.

Treatment of used oil as starting material with a metal bath is not known from the references mentioned.

It is an object of the invention to provide a process and an apparatus for purifying contaminated used oil, which makes efficient operation possible even in very small plants, so that a compact plant configuration and thus, in particular, mobile use is made possible by a container construction. A further object of the invention is to reduce the maintenance requirements.

In the process of the invention, contaminated oil-containing residues are automatically purified, condensed and thus converted within a few minutes back into usable fuel. Here, the process can combine known processes of the crude oil industry with a depolymerization process configured according to the invention for hydrocarbon-containing raw materials and so-called cold cracking technologies.

Polymers are usually produced from petroleum and, in simple terms, the hydrocarbons thereof are concatenated (polymerization) so as to form solid materials from a formerly liquid material. Depolymerization reverses this process. The chains are broken up again by the action of heat and products having shortened chain lengths, e.g. oils again (moderate length), but also waxes (somewhat longer chains, also liquid on heating) and gases (very short chains), which are all readily suitable for producing energy, and in the case of the oils also able to be stored and transported very well, arise. These can also be used as starting material of the process of the invention.

The objects of the invention are achieved by the used oil being used as starting material and being subjected to vaporization by at least indirect contact of the starting material with a melt bath, the melting temperature of which is above the vaporization temperature but below the ignition temperature of the used oil, and the vapor being rectified in the rectification column.

The used oil is distilled in the process. Here, the specific energy introduction system in the main reactor ensures very controllable and rapid heating of the used oil.

One embodiment of the process of the invention provides for a flash evaporation to be carried out by the starting material being introduced directly into the melt bath. This flash evaporation occurs within a few milliseconds. The flash evaporation or flash pyrolysis separates off undesirable materials and converts the oil fraction highly efficiently into the gas phase.

In another embodiment of the process of the invention, it is provided that the starting material is introduced indirectly into the melt bath by being passed through the melt bath without a direct connection and via a thermally conductive connection with said melt bath. This heat conduction evaporation ensures uniform energy input into the used oil, which avoids slag formation on the heat exchanger surfaces and thereby at least considerably reduces the maintenance requirement.

A common aspect of the embodiments of the process of the invention is the use of a melt bath. Here it is possible to use liquid metal as melt bath. It is possible here to use tin or lead as metal.

In every embodiment, the gas phase is separated into predefined and controlled fractions from high boilers to low boilers in a special rectification process which has hitherto been the preserve of the heavy oil industry. Various distillate grades are obtained in this way. Fuels suitable for engines are discharged, and unclean fractions can go through the process again until they have been separated completely into usable constituents and waste constituents. The various oil fractions are refined further depending on the field of use or supplied in the form of finished products to distributors or end customers. In the discharge of waste, from 5 to 10 percent of the raw material is obtained as tar-like waste. This can be used for bitumen production in road construction or as substitute fuel. Further wastes are not formed. The use of the rectification process in the small plant sector, combined with melt bath evaporation, is the key point of the invention.

Furthermore, it is possible for an onboard generator to supply the apparatus with energy from self-produced fuel or from a residual gas. Such an apparatus then operates self-sufficiently in terms of energy. In this way, a total efficiency of about 75% is achieved at present. Every unit processes up to 1000 liters of raw material per day, but this can be expanded to a larger, unlimited amount of raw material by a modular construction.

In terms of apparatus, the object of the invention is achieved by the main reactor being configured as melt bath evaporator, by a reactor space being filled with a melt bath material having a melting point above the vaporization temperature but below the ignition temperature of the used oil, the reactor space being provided with a heating device and an inlet for the used oil being arranged in the reactor.

In an embodiment of the apparatus of the invention, a direct thermally conductive connection between the used oil and the melt bath can be realized in the reactor space by the inlet into the reactor being formed directly into the melt bath.

A fluid to be vaporized or depolymerization material is fed into the lower part of a reactor tube which is filled with the melt bath as heat transfer medium, preferably a metal bath, and stands upright or is arranged at an angle.

The high convection energies for heat transfer which occur in melt baths are able to transfer the stored energy in milliseconds to the fluid to be vaporized.

However, when melt baths are utilized as heat transfer media, uncontrolled explosions can occur, with the consequence that a loss of the heat transfer medium has to be expected.

In this process step, very large gas bubbles which depressurize/burst at the surface are formed. As a result, part of the metal bath is entrained and accumulates at the bottom of the reactor or blocks conduits and the like. If this effect is taken as given, the consequence is that the process has to be interrupted after defined periods of operation and the metal bath has to be brought back in a costly manner to its original amount.

The achievement of the object of the invention is aimed at avoiding interruption of the operating times. For this purpose, the metal bath losses occurring in continuous operation are countered in melt bath reactors.

For this purpose, the large gas bubbles formed in the convection reaction can be made smaller in order to minimize the entrainment of metal bath on depressurization of these gas bubbles. It is possible here to fill the reactor zone with filling materials such as steel balls, so that the gas bubbles then divide on passing through the reactor zone and arrive as small bubbles on the surface of the metal bath. Two important advantages are created by means of these filler materials. Firstly, entrainment of the metal bath is reduced to a minimum and secondly an improved evaporation rate is achieved in the process since the gas can become better distributed.

In a further embodiment of the apparatus, a metal bath runback is ensured by means of impingement plates, as a result of which metal bath splashes are returned directly to the metal bath. For this purpose, impingement plates located one after the other are installed above the melt bath in the vapor flow direction, with each of these impingement plates having a lateral opening and these openings being offset in such a way that they are not above one another in the vapor flow direction but instead cover one another.

The impingement plates can be arranged in the reactor space of the main reactor.

A metal bath runback can also be provided. The metal bath runback is a component which has been specifically constructed for this use in order to collect very small amounts of liquid metal in the reactor space, above the metal bath surface, and return them to the reactor zone. Despite the steel balls, very small amounts which are caught in the metal bath runback can still occur and are returned to the reactor. The component ensures that gas can flow through but liquid metal becomes caught and flows back into the actual metal bath.

However, a different solution can also be chosen for avoiding melt bath losses. This provides for an indirect thermally conductive connection to be provided between the used oil and the melt bath in the reactor space by a dividing wall which separates the used oil from the melt bath being provided between the used oil and the melt bath.

A heat energy input into the used oil by thermal conduction is realized by means of the thermally conductive connection, with the excellent properties of the melt bath for equalizing the temperature differences being utilized in order to bring about vaporization without slag formation or similar phenomena, as is the case, for example, for the known tube ovens, occurring on the thermally conductive connection.

For implementation, a heat exchanger having an inlet and an outlet can be installed in the reactor space of the main reactor, with the inlet forming the entry point for the used oil and the outlet thereof opening into the inlet of the rectification column.

Highly efficient and uniform energy input into the used oil is realized by means of such a heat exchanger, without melt bath losses resulting from bursting gas bubbles in the melt bath being able to occur.

The heat exchanger can be configured as a tube, one end of which forms the inlet and the other end of which forms the outlet. This tube can be helically wound.

The melt bath, in particular a metal bath, surrounds the heat exchanger. The melt bath brings about uniform energy input since freshly fed-in used oil firstly has to be heated. The large heat capacity of the melt bath allows rapid heating of the used oil without an appreciable lowering of the temperature of the melt bath or slag formation at the point of energy input being able to occur.

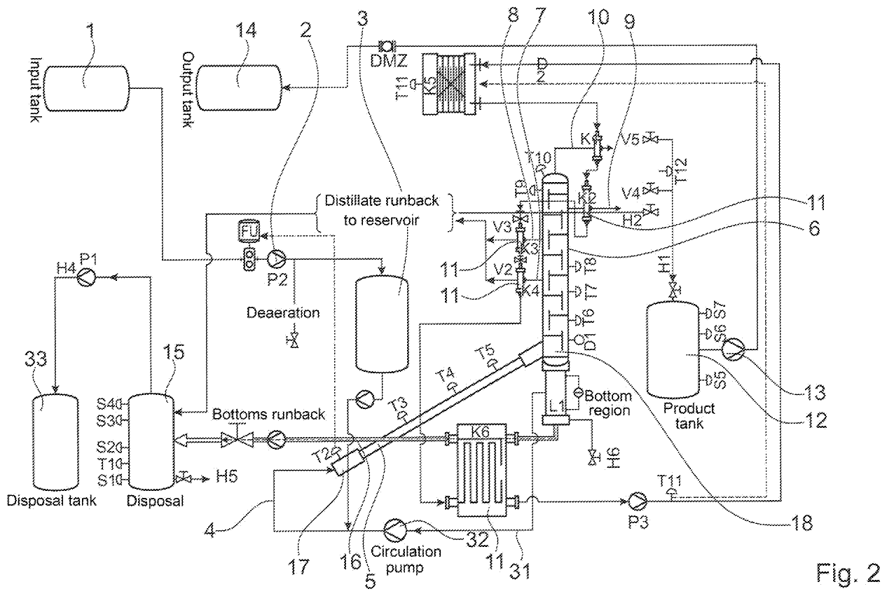

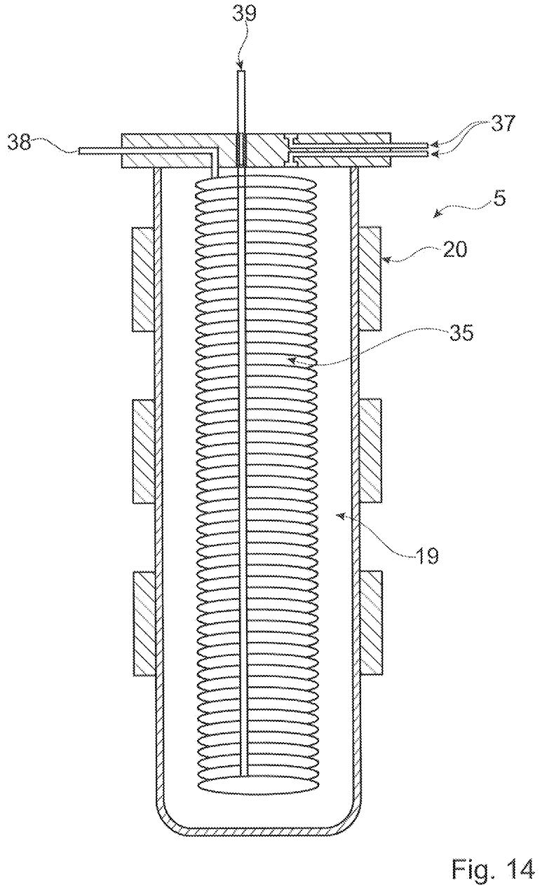

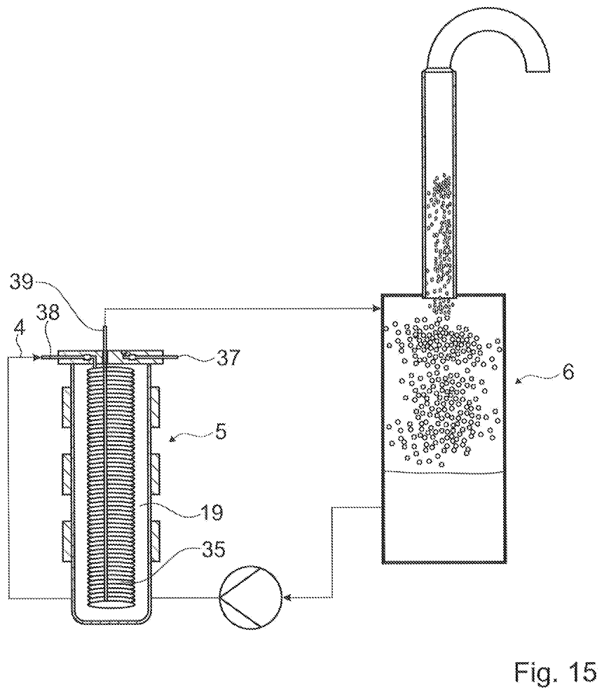

The invention will be described in detail below with the aid of a first working example (FIGS. 2 to 13) and a second working example (FIGS. 14 to 17). The accompanying drawings show:

FIG. 1 a depiction of the prior art,

FIG. 2 a schematic overall view of an apparatus for purifying contaminated used oil according to a first working example,

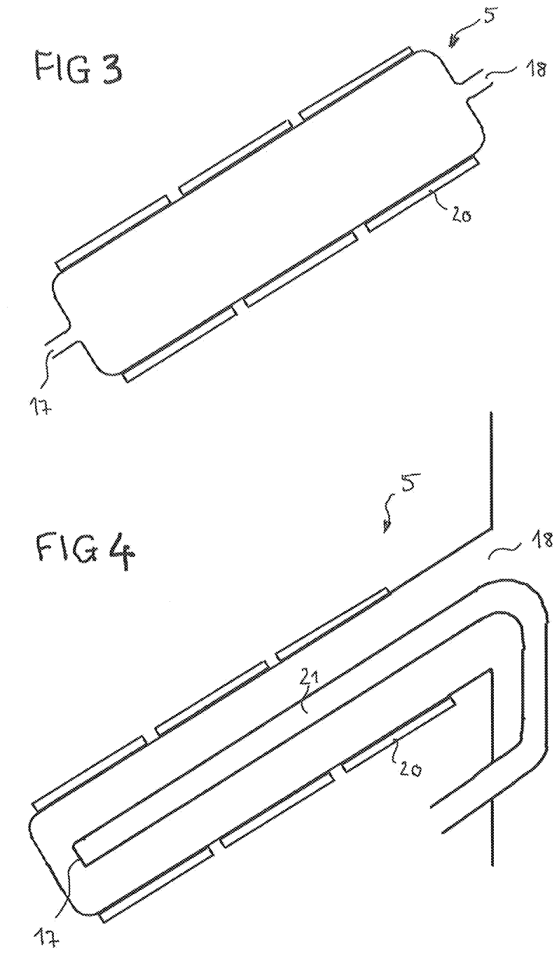

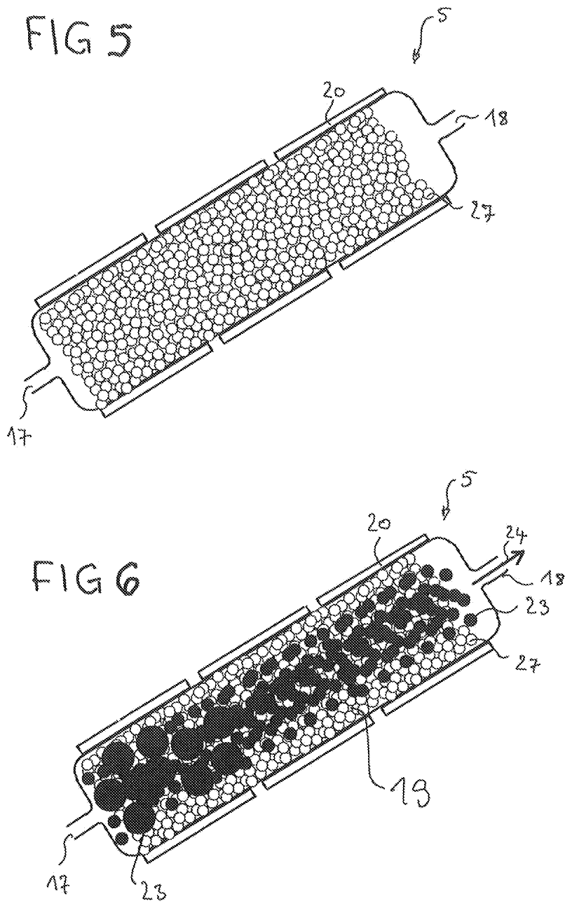

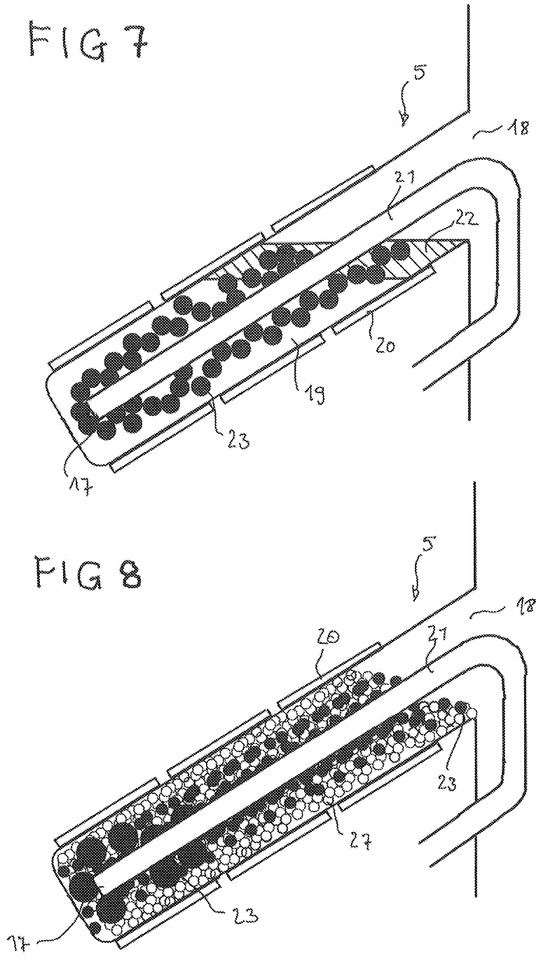

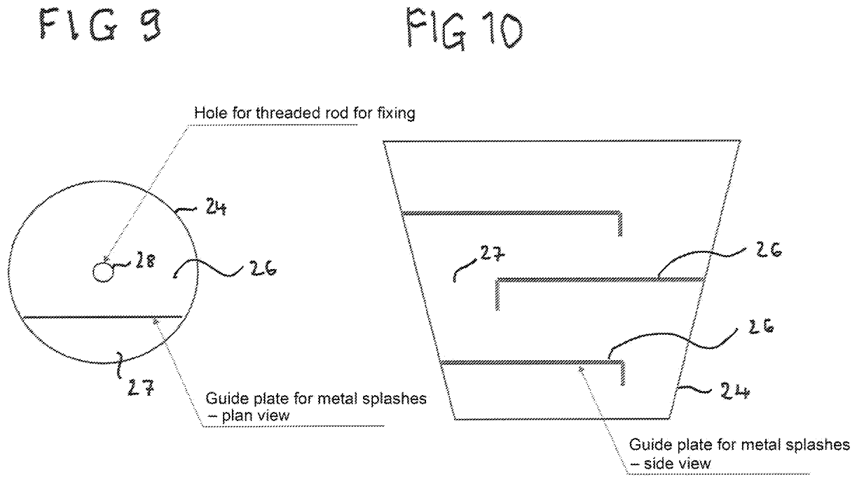

FIG. 3 a configuration of a main reactor for a flow-through principle,

FIG. 4 a configuration of a main reactor for a countercurrent principle,

FIG. 5 the main reactor for the flow-through principle with packing elements,

FIG. 6 the main reactor of FIG. 4 with bubble dispersion of the depolymerization material,

FIG. 7 the main reactor for the countercurrent principle with bubble dispersion of the depolymerization material,

FIG. 8 the main reactor for the countercurrent principle with packing elements and bubble dispersion of the depolymerization material,

FIG. 9 an in-principle depiction of a metal bath runback in plan view,

FIG. 10 the metal bath runback in cross section,

FIG. 11 an arrangement of the metal bath runback on the main reactor,

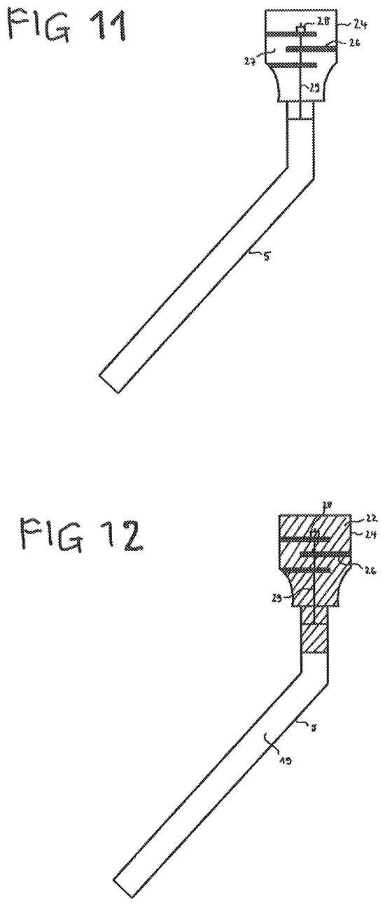

FIG. 12 the arrangement of the metal bath runback as per FIG. 10 with a metal bath filling and unvaporized part and

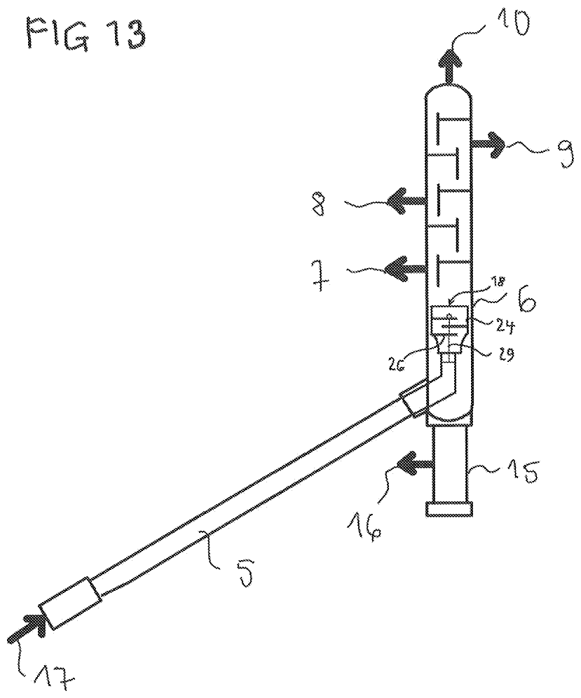

FIG. 13 an in-principle depiction of the apparatus in cross section,

FIG. 14 a main reactor according to the heat conduction-evaporation principle as per a second working example,

FIG. 15 a schematic total overview of an apparatus for purifying contaminated used oil according to the second working example,

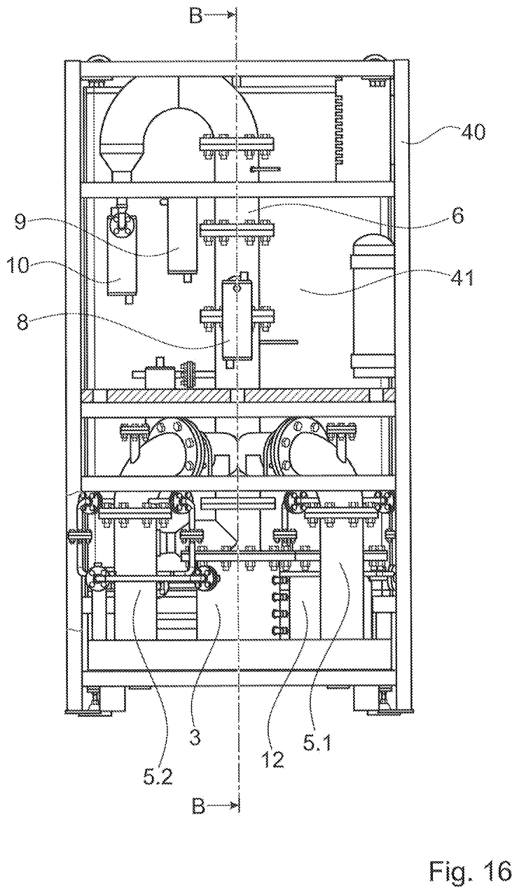

FIG. 16 a front view of an apparatus according to the invention according to the second working example,

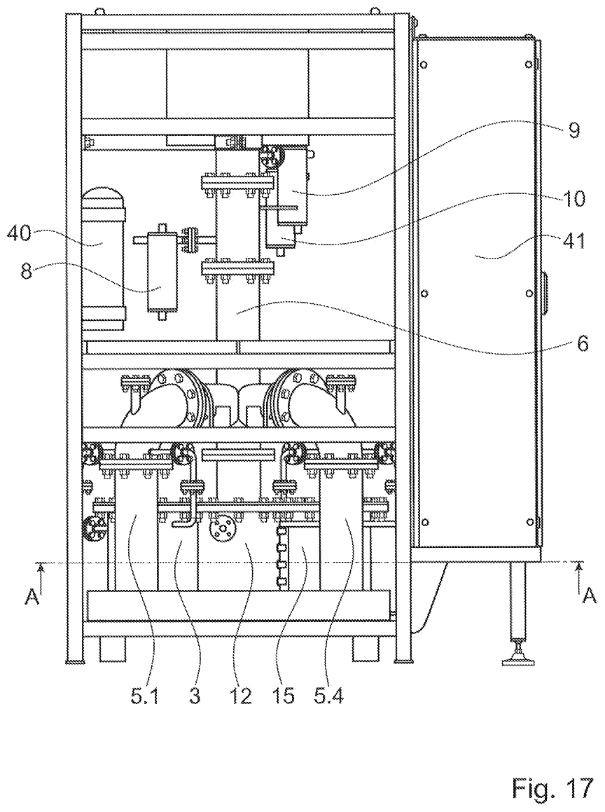

FIG. 17 a sectional view corresponding to the section line B-B in FIG. 16,

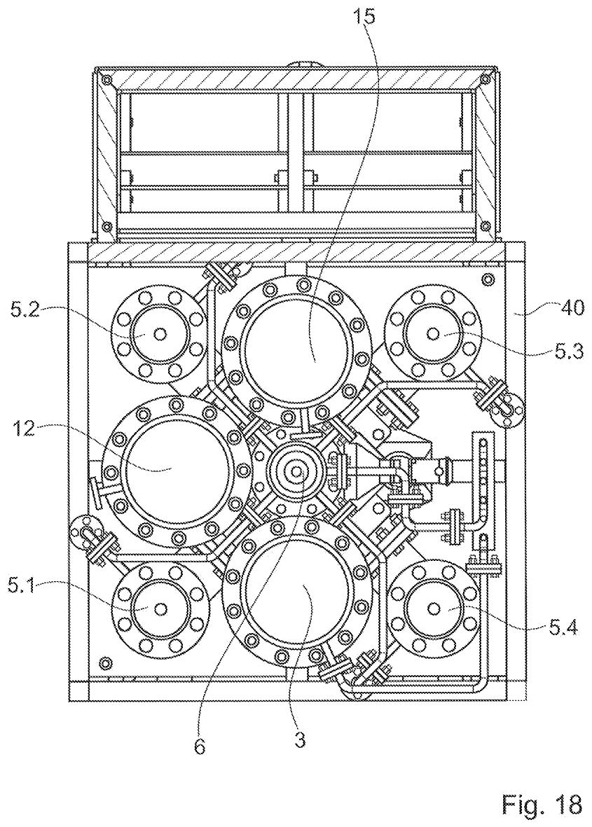

FIG. 18 a cross-sectional view corresponding to the line A-A in FIG. 17 and

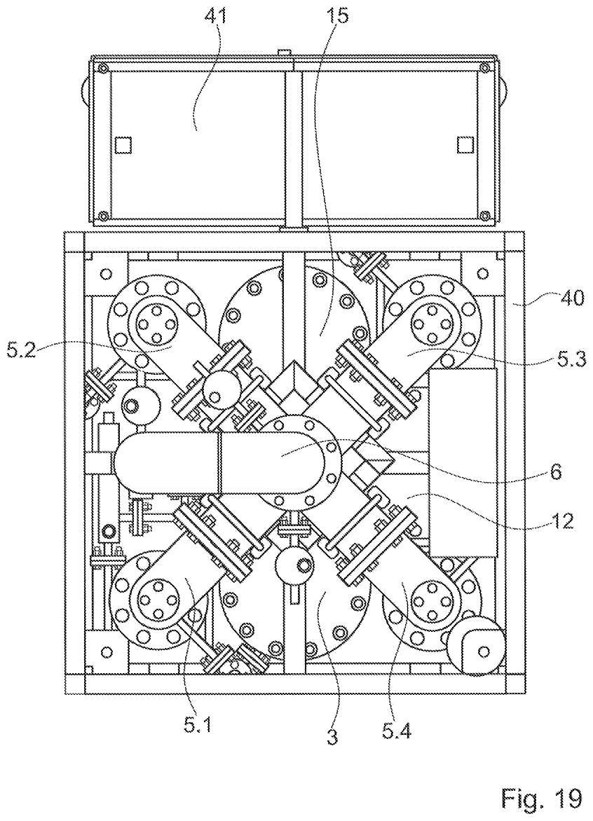

FIG. 19 a plan view of the arrangement according to the invention of the second working example.

As shown in FIG. 1, the crude oil is, according to the prior art, heated to above 360° C. in the tube oven T1 so that the constituents largely vaporize. These go into the distillation tower T2 which is made up of numerous bubble cap trays T3. The distillates T4 to T9 of the individual fractions collect in the bubble cap trays T3. As can be seen, the tube T10 in which the used oil is conveyed comes into direct contact with the heating gas generated by the combustion chamber T11. The heating gas does not become distributed uniformly on the hot side in the tube oven T1, so that partial overheating of the tube T10 occurs. The heat capacity of the heating gas is also low, so that it is necessary to work using large temperature differences, i.e. the heating gas is strongly heated, which can again lead to overheating of the tube T10. As a result, slag formation in the interior of the tube T10 cannot be avoided and the slag deposits have to be removed in the course of regular maintenance work. However, such maintenance work prohibits mobile use of such apparatuses.

In a first embodiment of the invention, contaminated used oil is, as shown in FIG. 2, provided in an external input tank 1 for the purpose of purification by the depicted apparatus according to the invention. From this input tank 1, this used oil is pumped by means of a reservoir pump 2 into an internal reservoir 3 and from there pumped out into the main reactor 5. The amount of used oil fed in is regulated via the temperature in the rectification column 6 as controlled variable.

Before the fresh used oil fed in enters the main reactor 5, the used oil becomes mixed with runback streams of distillate and bottoms as described below to form a depolymerization material 4 which is fed into the main reactor 5 and in this is vaporized suddenly by means of a so-called flash evaporation.

It may already be mentioned here that the actual in-principle flow through the apparatus, as is depicted in FIG. 2, also applies to the second working example. The difference lies essentially in the main reactor. In the second working example, no flash evaporation but instead heat conduction evaporation occurs in the main reactor. However, steam which is fed into a rectification column 6 is formed in both working examples. In this rectification column, the vapor condenses in various stages, i.e. at various temperatures. Offtakes 7 to 10 are provided at these stages. While the condensate at the first side offtake 7 and the second side offtake 8 is, after cooling via heat exchangers 11, fed back to the reservoir 3, the product, i.e. a purified oil, is taken off from the third side offtake 9 and the overhead offtake 10 and likewise cooled by means of heat exchangers 11 and fed into a product tank 12. From this, it is then conveyed by means of a product pump 13 into an output tank 14.

Condensate which is not discharged via the offtakes 7 to 10 and constituents of the depolymerization material 4 which are not vaporized and float in the metal bath of the main reactor 5 are fed via a circulation conduit 31 by means of a circulation pump 32 back into the main reactor 5 for renewed vaporization as depolymerization material 4.

The proportions of the condensate which can no longer be distilled accumulate as bottoms at the bottom of the rectification column. From there, the bottoms are fed via a bottoms runback 16 to the disposal container 15. From there, the contents of the disposal container 15 can if required to an external disposal tank.

As depicted in FIG. 3, the main reactor 5 can be configured on the flow-through principle. Here, the inlet 17 for the depolymerization material 4 is located at the low end and the outlet 18 is located at the upper end. A metal bath 19 which consists of a metal having a melting point above the vaporization temperature of the depolymerization material 4 is present in the main reactor 5. The metal is kept in the liquid phase by means of heating sleeves 20. Since the depolymerization material 4 is vaporized immediately by the temperature of the metal bath 19, which in the liquid phase has to be above the vaporization temperature, as soon as it reaches the inlet into the metal bath 19, this is referred to as flash evaporation.

Two variants for configuring the main reactor are depicted in FIG. 3 and FIG. 4. FIG. 3 represents the flow-through principle in which the depolymerization material 4 is fed through the inlet 17 arranged directly on the underside of the main reactor 5 directly to the underside of the metal bath 19 and vaporizes immediately there.

FIG. 4 represents the countercurrent principle in which the inlet 17 has a countercurrent tube 21. Through this countercurrent tube 21, the depolymerization material 4 is conveyed through the metal bath 19. During passage through this tube, the depolymerization material 4 is heated almost to the vaporization temperature, so that the flash evaporation proceeds even more quickly on exit from the inlet 17.

As indicated in FIG. 7, parts of the depolymerization material 4 are not vaporized by the temperature of the metal bath 19. The unvaporized part 22 is usually made up of relatively long-chain compounds which largely originate from the contamination of the used oil in the input tank. As can be seen from FIG. 7, this part 22 floats on the metal bath 19 and at the connecting edge between main reactor 5 and rectification column flows into the bottoms container 15. This can thus be fed together with the remaining bottoms to renewed rectification.

As shown in FIG. 7, the vapor bubbles 23 which arise are depressurized at the surface of the metal bath 19 and burst. To prevent parts of the metal bath 19 being entrained in the expansion of the vapor bubbles 23 and then arriving at the end in the bottoms container 15 or blocking conduits so as to minimize the fill level of the metal bath 19, a metal bath runback 24 is arranged above the metal bath 19. This metal bath runback 24 can, for example, be arranged in the reactor space of the main reactor 5 or in the rectification column 6. This metal bath runback has impingement plates 26 located in the vapor flow direction 25, as is depicted in FIGS. 8 to 12. Each of these impingement plates 26 has a lateral opening 27, with these openings being offset so that they do not lie above one another in the vapor flow direction but instead cover one another. The impingement plates 26 can be clamped in the metal bath runback 24 by means of a nut 28 which is screwed onto a tension rod 29.

If metal droplets are emitted from the metal bath 19 and entrained by the vapor stream, they impinge on one of these impingement plates 25 and flow from there back into the metal bath 19.

To ensure that the metal of the metal bath 19 does not condense on the impingement plates 26, the latter should have a temperature above the melting point of the metal bath 19. This can be ensured by thermal conduction via the wall of the main reactor 5 and, in the case of the impingement plates being arranged in the rectification column 6, via the wall thereof. It is also possible to heat the impingement plates 25 in a manner which is not shown in more detail.

The principle of flowing down of the unvaporized part, as depicted in FIG. 7, can be seen in FIG. 12, here with the metal bath runback. In this case, the unvaporized part 22 likewise floats on the metal bath 19 but fills the metal bath runback 24 to its upper edge. Since the unvaporized part 22 always increases, the excess flows over the upper edge of the metal bath runback 24 into the bottoms container 15. As can be seen here, the impingement plates 26 are thus present in the unvaporized part 22. The metal splashes from the metal bath 19 thus arrive within the unvaporized part 22 at the impingement plates 26 and flow from there through the unvaporized part 22 back into the metal bath 19.

As shown in FIG. 5, a further measure for preventing discharge of material from the metal bath can be to introduce packing elements 27 into the main reactor 5. These packing elements can consist of a metal having a higher melting point than the metal bath 19 or other, if possible inert, materials, for example ceramic.

Such filling with packing elements 30 is possible both in the case of the flow-through principle as per FIG. 3, depicted in FIGS. 5 and 6, and in the case of the countercurrent principle as per FIG. 4, depicted in FIGS. 7 and 8. A combination of the packing elements 30 and metal bath runback 24, as depicted in FIGS. 11 to 13, is also possible.

As can be seen in FIG. 6 and FIG. 8, the effect is that the vapor bubbles 23 which exit from the inlet are still quite large and are broken up into smaller bubbles by the packing elements 30. Vapor bubbles 23 which have been made smaller in this way now have less energy for emitting metal splashes when bursting at the surface of the metal bath 19.

In the working example indicated above, tin is used as metal for the metal bath 19 for vaporizing used oil since the melting point of tin of 300° C. optimally matches the vaporization temperature of the used oil. However, it is also possible to use other metals. The use of other fusible materials is also possible. The important thing is just that the melting point of the fusible material used is equal to or greater than the vaporization temperature of the depolymerization material in each case. However, the melting point must not be chosen to be so high that combustion of the depolymerization material does not occur, even not partially.

This is also the advantage of the metal bath solution, or expressed more generally the melt bath solution. If specifically the depolymerization material is heated directly, i.e. without a melt bath, e.g. by heat energy input from the outside through the wall of the main reactor, overheating of the depolymerization material at the wall and thus deposition of combustion residues, which soon make costly cleaning of the main reactor necessary, inevitably occurs as a result of the temperature gradient.

Further fields of use of the melt bath solution are thus also apparent. For example, it becomes specifically possible to treat contaminated solvents or cleaning compositions or fuels. In particular, an embodiment of the apparatus which operates under reduced pressure will then be selected. However, it is also possible to feed granulated polymers into a melt bath, preferably a bath of metal. The vapors released as a result of heating can then be rectified to give valuable raw materials. However, other heat transfer media, e.g. saturated salt solutions, fusible polymers and even liquefied gases can also be used instead of the above-described metals as melt bath materials for a variety of fields of use.

The second working example, as depicted in FIGS. 14 to 19, is also directed to preventing a loss of melt bath and avoiding combustion residues.

FIG. 14 shows a main reactor 5 which has a reactor vessel 34. Heating sleeves 20 are arranged on the outside of the reactor vessel. Here, the heating devices can also be configured differently, for example, as an alternative, as induction heating devices.

The metal bath 19 is present in the interior of the reactor vessel 34. A heat exchanger or heating register 35 is immersed completely in this metal bath. The metal bath 19 thus flows, when it is liquefied, around the heating register.

The reactor vessel 34 is provided at the top with a flange 36 by means of which the reactor vessel 34 can be joined to the main reactor 5. This flange 36 is provided with an outflow hole 37 through which non-condensable liquid can be discharged directly to the bottom region.

The heating register consists of a spirally wound tube having a first end 38 and a second end 39. The cold used oil is introduced into the first end 38 and conveyed to the heating register 35 at its end facing the flange 36. The used oil which has been heated to give a vapor phase goes at the second end 39 into the rectification column 6 connected thereto. There, the distillation described above takes place.

FIG. 15 shows the principle that the used oil which has been heated to form the vapor phase is fed via the second end 39 to the rectification column 6 and vaporizes therein. The fractions of the used oil which do not yet condense correctly in the rectification column 6 are fed together with fresh used oil as depolymerization material 4 to the heating register 35 at its first end 38 in the main reactor.

FIGS. 16 to 19 show that the apparatus of the invention is arranged as transportable mobile facility in a frame 40. The reservoir 3, the product tank 12 and the disposal container 15 are located therein.

To increase the production capacity, four main reactors 5.1 to 5.4, the second ends of which each open into the rectification column 6 which is arranged centrally, and the construction as per FIG. 14 are provided.

A control 41 is provided for correct operation of the plant.

### LIST OF REFERENCE NUMERALS

1 Input tank
2 Reservoir pump
3 Reservoir
4 Depolymerization material
5 Main reactor
5.1-5.4 Main reactor
6 Rectification column
7 First side offtake
8 Second side offtake
9 Third side offtake
10 Overhead offtake
11 Heat exchanger
12 Product tank
13 Product pump
14 Output tank
15 Disposal container
16 Bottoms runback
17 Inlet
18 Outlet
19 Metal bath
20 Heating sleeves
21 Countercurrent tube
22 Unvaporized part
23 Vapor bubbles
24 Metal bath runback
25 Vapor flow direction
26 Impingement plate
27 Lateral opening
28 Nut
29 Tension rod
30 Packing elements
31 Circulation conduit
32 Circulation pump
33 Disposal tank
34 Reactor vessel
35 Heat exchanger, heating register
36 Flange
37 Outflow hole
38 First end
39 Second end
40 Frame
41 Control

1. A process for purifying contaminated used oil where the starting material is heated until it is in the gas phase and a vapor formed is rectified, where purified oil is taken off as condensate from an offtake in a rectification column, wherein the used oil is used as starting material and is subjected to vaporization by at least indirect contact of the starting material with a melt bath, having a melting point which is above the vaporization temperature but below the ignition temperature of the used oil and the vapor is rectified in the rectification column.

2. The process as claimed in claim 1, wherein a flash evaporation is carried out by the starting material being fed directly to the melt bath.

3. The process as claimed in claim 1, wherein the starting material is fed indirectly to the melt bath by being conveyed through the melt bath without a direct connection and via a thermally conductive connection with said melt bath.

4. The process as claimed in claim 1, characterized in wherein liquid metal is used as melt bath.

5. The process as claimed in claim 4, wherein tin or lead is used as metal.

6. The process as claimed in claim 1, wherein a condensate is fed to renewed rectification.

7. An apparatus for purifying contaminated used oil, comprising a main reactor and a rectification column connected thereto, wherein the main reactor is configured as melt bath evaporator, by a reactor space being fillable with a melt bath material having a melting point above the vaporization temperature but below the ignition temperature of the used oil, the reactor space being provided with a heating device and an inlet for the used oil being arranged in the reactor.

8. The apparatus as claimed in claim 7, wherein a direct thermally conductive connection between the used oil and the melt bath is realized in the reactor space by the inlet into the reactor being formed directly into the melt bath.

9. The apparatus as claimed in claim 8, wherein impingement plates located behind one another in the vapor flow direction are installed above the melt bath, where each of these impingement plates has a lateral opening, where these openings are offset in such a way that they do not lie above one another in the vapor flow direction but instead cover one another.

10. The apparatus as claimed in claim 8, wherein the impingement plates are arranged in the reactor space of the main reactor.

11. The apparatus as claimed in claim 9, wherein an indirect thermally conductive connection between the used oil and the melt bath is provided in the reactor space by a dividing wall by means of which the used oil is separated from the melt bath being provided between the used oil and the melt bath.

12. The apparatus as claimed in claim 11, wherein a heat exchanger having an inlet and an outlet is installed in the reactor space of the main reactor, with the inlet forming the entry point for the used oil and the outlet thereof opening into the inlet of the rectification column.

13. The apparatus as claimed in claim 12, wherein the inlet is arranged on the side of the main reactor facing the rectification column and the outlet is arranged on the side of the main reactor facing away from the rectification column.

14. The apparatus as claimed in claim 13, wherein the heat exchanger is configured as a tube whose one side forms the inlet and whose other side forms the outlet.

15. The apparatus as claimed in claim 13, wherein the tube is helically wound.

16. The apparatus as claimed in claim 14, wherein the tube is helically wound.

17. The process as claimed in claim 2, wherein liquid metal is used as melt bath.

18. The process as claimed in claim 3, wherein liquid metal is used as melt bath.

19. The process as claimed in claim 2, wherein a condensate is fed to renewed rectification.

20. The process as claimed in claim 3, wherein a condensate is fed to renewed rectification.
